(19) United States
(12) Patent Application Publication
(10) Pub. No.: US 2009/0094276 A1
(43) Pub. Date: Apr. 9, 2009

(54) System for the unique identification of physical and virtual objects

(76) Inventor: Mark Schenecker, Colorado Springs, CO (US)

Correspondence Address: SAP / FINNEGAN, HENDERSON LLP, 901 NEW YORK AVENUE, NW, WASHINGTON, DC, 20001-4413, US

(21) Appl. No.: 11/905,639

(22) Filed: Oct. 3, 2007

(51) Int. Cl. G06F 17/30

(52) U.S. Cl. 707/103 R; 707/E17.046

(57) ABSTRACT

A system and method that provides framework components identifying, for example, an identification scheme agency, a particular scheme, and a scheme version are used to encapsulate a physical or virtual object instance to enable unique identification of the object. Identification may be made unique globally across information systems, industries, value chains, and information system other barriers by allowing an information system to determine scheme agencies, schemes, and scheme versions associated with the object instance.

### TECHNICAL FIELD

The field of the invention relates in general to object identification schemes. More particularly, the field of the invention relates to a harmonized global identification system that enables unique identification of a physical or virtual object across any number of internal or external information systems.

### BACKGROUND

Many computerized identification schemes facilitate unique identification of physical and/or virtual objects within information systems. In almost all cases, the identification scheme is specially designed to work within a particular system scope. The system scope may encompass, for example, the particular information system that defines the objects, a network to which the information system that defines the objects belongs, or any other suitable grouping of information systems.

However, the identification scheme is often ignorant of any other identification scheme used outside of that system scope. As a consequence, the scheme is incapable of accurately defining an identifier for an object in a manner that would ensure unique identification of the object in another information system using a different identification scheme. Currently, there is no known identification scheme that is capable of seamlessly carrying out the unique identification of objects across a heterogeneous landscape of independent information systems.

A first major category of today's actively used identification schemes are those that operate within a single information system. The schemes are typically used to uniquely identify objects that interact within the boundaries of a particular information system. The objects may be either physical objects or virtual objects.

Physical objects may include, for example, finished retail products, unfinished parts used in manufacturing, shipping containers, and many other suitable tangible objects. Identification of physical objects may be useful, for example, during supply chain operations such as inventorying. Most identification schemes identify a physical object by first categorizing the physical object into an object class and then associating a serialized identification with the physical object.

Virtual objects, on the other hand, do not exist physically, but are rather data instances that are capable of being precisely referenced, for example, by an information system in which it is defined and/or by an external system. Examples of virtual objects may include, for example, instances of purchase orders, invoices, ship notices, pick lists, and any other suitable data instances. Today, it is not unusual to find thousands of such data instances or virtual objects in a single information system.

A unique identification scheme built into an information system typically assigns an ID to a physical or virtual object from a predefined number range. Ideally, the identification scheme achieves unique assignment by ensuring that the same ID will not be reassigned to another object. Unfortunately, due to finiteness of the predefined number range and/or the capacity of the information system, IDs may be recycled, for example, after a fixed period of time. In these situations, unique identification may be preserved by combining the ID with, for example, a date/time stamp.

Identification schemes that are built into an information system have a number of disadvantages. Because such schemes are separate from and ignorant of other information schemes that are external to the information system, IDs that are unique in one system are often duplicated in another system. This duplication prevents an identifier to an object from becoming portable across a heterogeneous system landscape (i.e., one involving multiple information systems) and creates ambiguity that generates processing errors.

A second major category of identification schemes are those that operate based on a specification developed, for example, by a standards organization. These standards-based identification schemes have been used across information systems, for example, information systems of trading partners in a supply chain. As an example, to enable an object identification to cross information systems in a supply chain, each information system involved in the chain must conform to a common standard scheme for object identification. For example, a standards-based identification scheme may provide a common number range that is managed by a standards organization or a third party that allocates identifiers from that number range to identify objects in the various information systems.

A number of well-known standards-based schemes have emerged in the past decades. Some of the most notable standard-based schemes are listed below in Table 1.

TABLE 1

| Standard-based Scheme | Description |
|---|---|
| University Product Code | provides unique identifiers to retail |
| (UPC) | products in the form of barcodes |
| Electronic Product Code | provides unique identifiers for |
| (EPC) | physical objects in the form of |
| | radio frequency identification tags |
| Electronic Serial Number | provides unique identifiers for cell |
| (ESN) | phones |
| Vehicle Identification | provides unique identifiers for |
| Number (VIN) | motor vehicles. |
| International Standard Book | provides unique identifiers for |
| Number (ISBN) | books |

Standards-based identification schemes are generally successful in uniquely identifying physical objects as they move across information systems as long as each of these information systems conforms to the same standards-based identification scheme. For example, information systems that conform to the same standards-based identification scheme within a supply chain may each track, inventory, and otherwise manage a product to prevent theft, facilitate efficient restocking, track the physical location, and conduct other beneficial activities based on the needs of a particular information system.

Existing standards-based identification schemes are mostly organized, however, to facilitate object reorganization in a heterogeneous landscape of vertical information systems (e.g., a supply chain). They typically do not address identification needs in a global marketplace that requires horizontal as well as vertical portability of objects. When it comes to object identification across industries, most standards-based identification schemes encounter the same problems as those described in connection with identification schemes that are internal to information systems. In particular, an ID created based on one standard that is suitable and unique to a particular value chain or industry may lose its uniqueness when it crosses into industries or value chains using other standards-based identification schemes. These other schemes may, for example, duplicate the same ID to represent another object. The ambiguity created by such duplication may generate many processing errors. In addition, many standards-based schemes have become entrenched in their respective industries and have amassed a significant group of processes and operations based upon them. Consequently, elimination of such schemes in lieu of another scheme that is more suitable for a global marketplace has become very difficult, if not impossible.

Nevertheless, some standards-setting organizations have recognized the need for a more global approach to object identification. These organizations have begun creating new identification schemes that may be applied more broadly, for example, across industries and value chains. One such organization is EPCglobal, which is attempting to establish itself as the sole agency for allocating IDs used in association with Radio Frequency Identification (RFID) tags. The basic idea of EPCglobal's scheme is to require all enterprises and/or entities that wish to assign RFID tags to register or become members of EPCglobal, which will then manage the RFID tags for these enterprises and/or entities to ensure uniqueness. This essentially creates a monopoly for RFID assignment in one agency, to which each member must pay rather expensive fees. The high fee and rigid format of this scheme has deterred adoption by many organizations. Also, RFID tags are typically used to identify physical objects. Therefore, EPCglobal's scheme does not provide assistance in the area of transporting virtual objects across information systems.

In view of the above, a need exist for a system and method for enabling unique identifiers of both physical and virtual objects that are either assigned internally within an information system and/or assigned in accordance with a standard-based identification scheme to be harmonized and made unique globally across information systems, industries, value chains, and other barriers.

### SUMMARY

Consistent with the principles of the present invention, a system and method enables unique identifiers of both physical and virtual objects to be uniquely recognized across information systems, industries, value chains, and other barriers.

In some embodiments, a unique identifier associated with a scheme agency that is responsible for a scheme used to construct an identifier for an object instance may be identified. The scheme agency may be, for example, a standards-setting organization such as EPCglobal or any other suitable agency.

In some embodiments, a unique identifier associated with the particular scheme that is used to construct the identifier for the object instance may also be identified. The scheme may determine how the identifier of the object instance is constructed, including, for example, a definition for each part of the object instance identifier.

In some embodiments, a version identifier may be additionally defined. The version identifier may determine the specific version in the lifecycle of the scheme that was responsible for the construction of the object instance identifier.

The object instance identifier may be encapsulated, for example, within the unique identifier associated with the scheme agency, the unique identifier associated with the scheme, or, in some embodiments, the unique identifier associated with the version of the scheme. The encapsulation as a whole may enable an external information system to uniquely identify the object instance.

In some embodiments, the identifier of the object instance may be encoded on an RFID tag. Additionally, the identifiers associated with the scheme agency, the unique identifier associated with the scheme, and/or the unique identifier associated with the particular version of the scheme may be appended to the RFID tag, for example, as header information.

In some embodiments, the identifier of the object instance may be encoded in a barcode. Additionally, the identifiers associated with the scheme agency, the unique identifier associated with the scheme, and/or the unique identifier associated with the particular version of the scheme may be embedded in the barcode.

In some embodiments, the object instance may be a virtual object instance. The particular scheme used to construct the identifier for the virtual object instance may include a system identifier identifying an information system from which the identifier for the virtual object instance is generated, a system scheme identifier identifying an identification scheme of the information system based on which identifier for the virtual object instance is generated, and/or a version identifier identifying the particular version of the identification scheme.

The virtual object instance identifier may be encapsulated, for example, within the system identifier, the system scheme identifier, and/or the version identifier. The encapsulation as a whole may enable a heterogeneous landscape of information systems to uniquely identify the object instance.

Further features and embodiments of the present invention will become apparent from the description and the accompanying drawings. It will be understood that the features mentioned above and those described hereinafter may be used not only in the combination specified but also in other combinations or on their own, without departing from the scope of the present invention. It will also be understood that the foregoing background, summary, and the following description of the systems consistent with the principles of the present invention are in no way limiting on the scope of the present invention and are merely illustrations of a preferred embodiment of the present invention.

### BRIEF DESCRIPTION OF THE DRAWINGS

Referring now to the drawings, in which like numerals represent like elements throughout the several Figures, aspects of the present invention and the exemplary operating environment will be described.

FIG. 1 is a schematic block diagram illustrating the relationships among HGIS framework components in one embodiment.

FIG. 2 is an exemplary table showing unique identifiers of agencies and schemes in one embodiment.

FIG. 3 is a block diagram of an illustrative RFID system for facilitating reading and writing to a read/write RFID tag in one embodiment.

FIG. 4 is an illustrative EPC encoded on a RFID tag in accordance with the 96-bit EPCglobal tag data standard.

FIG. 5 is an illustrative RFID tag having HGIS framework components appended as header information in one embodiment.

FIG. 6 is a schematic block diagram illustrating the relationships among EGIS framework components associated with an ID instance of a virtual object in one embodiment.

FIG. 7 is an exemplary virtual object instance containing multiple identifiers in one embodiment.

FIG. 8 shows a computer system capable of implementing elements of the EPCIS framework.

FIG. 9 shows another computer system capable of implementing elements of the EPCIS framework.

### DETAILED DESCRIPTION

The following detailed description refers to the accompanying drawings. Wherever possible, the same reference numbers are used in the drawings and the following description to refer to the same or similar parts. While several exemplary versions and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding stages to the disclosed methods. Accordingly, the following detailed description does not limit the invention. Instead, the proper scope of the invention is defined by the appended claims.

Consistent with the principles of the present invention, a method and system is provided to establish a framework in which unique identifiers of both physical and virtual objects that are either assigned internally within an information system and/or assigned in accordance with a standard-based identification scheme may be harmonized and made unique globally across information systems, industries, value chains, and other barriers. For simplicity, this system will be referred to hereinafter as a Harmonized Global Identification System (HGIS). It will be understood that any other suitable system name may be used without departing from the spirit of the present invention.

At a high level, the HGIS framework may be provided as a harmonizing object identification framework that is made open and free to the public at large. The HGIS scheme may coexist with both existing schemes that are currently been used to identify objects (i.e., those within a specific information system and those based on standards that are used for object identification across conforming information systems in particular industries and value chains). More specifically, the HGIS framework may provide encapsulating framework components as a wrapper for a unique identifier generated by an existing scheme without requiring modification of the existing scheme. The added HGIS framework components may ensure that the unique identifier generated based on the existing scheme is uniquely and globally recognized across information systems and/or across industries.

In a nutshell, the HGIS framework components may provide the metadata to precisely identify the context of an identifier generated by an existing scheme. The context may be such that it provides the specific semantics necessary for proper use of the identifier.

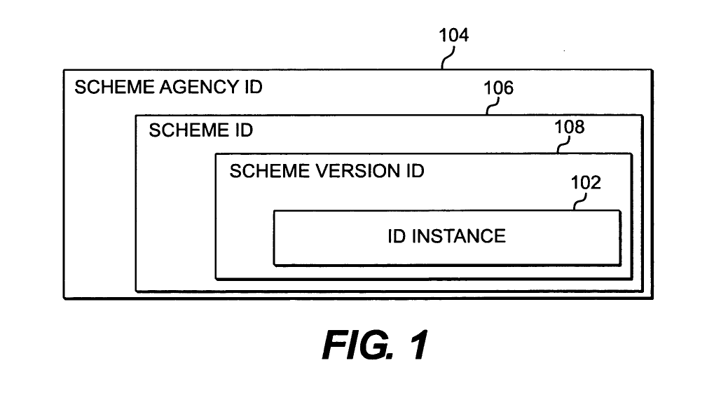

FIG. 1 illustrates one example of an identifier instance generated by an existing scheme that is encapsulated within HGIS framework components. In this example, an identifier instance 102 may be generated by an existing scheme, such as an identification scheme internal to an information system or a standard-based identification scheme. The identifier instance 102 may be, for example, a Universal Product Code (UPC) that identifies a retail product, an Electronic Product Code (EPC) that identifies an item in a supply chain, a Vehicle Identifier Number (VIN) that identifies a car, or any other suitable unique identifier according to a variety of identification schemes such as the examples shown above in Table 1.

The HGIS framework may provide three framework components 104-108 to wrap around or encapsulate identification instance 102 in order to provide sufficient semantics information for global recognition of identification instance 102. The three framework components may include a scheme agency identifier 104 that uniquely specifies, for example, an agency that is responsible for managing the particular identification scheme used to generate identification instance 102. As an example, for an identification instance that is an Electronic Product Code generated based on a standard maintained by the standards organization EPCglobal, scheme agency ID 104 may be an ID that globally identifies EPCglobal as the responsible agency for managing identifier instance 102.

Because each agency identified by scheme agency ID 104 may manage one or more schemes for object identification, the HGIS framework components may further include a scheme ID 106 to uniquely identify the particular scheme maintained by an agency that is specifically responsible for the identification of identifier instance 102. Generally, the scheme represented by scheme ID 106 determines the semantic definitions for each part of identifier instance 102, so when the scheme becomes uniquely identifiable through scheme ID 106, the structure of identifier instance 102 may be understood by any information system using the scheme's specifications.

In many cases, existing identification schemes go through evolutions and modifications during its lifecycle resulting in new versions of the scheme being promulgated. Sometimes the modification of a scheme creates differences in the structure of ID instance and hence modification of the original scheme definition. To accommodate such evolutions in existing schemes, the HGIS framework may provide an additional scheme version ID 108 to uniquely identify the particular version of the scheme under which identifier instance 102 may be created.

In the manner illustrated above, the HGIS framework may create a unique global identifier that comprises an ID instance generated based on a variety of identification schemes, which is then encapsulated within a number of HGIS framework components. No modification needs to be made to the existing schemes that generate the identifier instances, and each HGIS framework component need only be unique with respect to the HGIS framework component above it. For example, scheme ID 106 need only be unique within scheme agency ID 104, while scheme version ID 108 need only be unique with respect to scheme ID 106. In this way, maintenance efforts may be minimized at every level, while the combination of the encapsulated identifier instance may be globally unique from all other such encapsulated identifiers.

The basic foundation that enables the HGIS framework components to provide sufficient context to allow unique identification of an identifier instance includes an efficient and globally-accessible repository or other suitable mechanism for maintaining the framework components, such as scheme agency ID 104, scheme ID 106, scheme version ID 108, and/or any other suitable framework components. In one applicable approach, the HGIS framework components may be maintained and supported, for example, by an internationally recognized standards development organization that is capable of providing a public and open forum. One suitable organization may be the United Nations Centre for Trade Facilitation (UN/CEFACT). In fact, UN/CEFACT has already initiated a program, DE3055, in an effort to capture and manage the various scheme agencies and their identification schemes. While UN/CEFACT's existing program does not provide the necessarily HGIS framework for achieving globally unique identification of objects as described above, UN/CEFACT shares the same spirit with the HGIS framework in its wish to harmonize the various identification schemes currently in existence. It will be understood that while UN/CEFACT is specifically mentioned as a suitable entity/organization for maintaining the HGIS framework, any other suitable entity/organization may be used without departing from the spirit of the present invention.

At a high level, an entity/organization that manages the HGIS framework may encode the participating agencies and their corresponding identification schemes to provide an unambiguous description for allowing access to the agency and scheme information by an information system. The encoding of the HGIS framework components may also accommodate any limitations in physical devices that may be used to transport the encoded components, for example, in the form of barcodes or RFID tags.

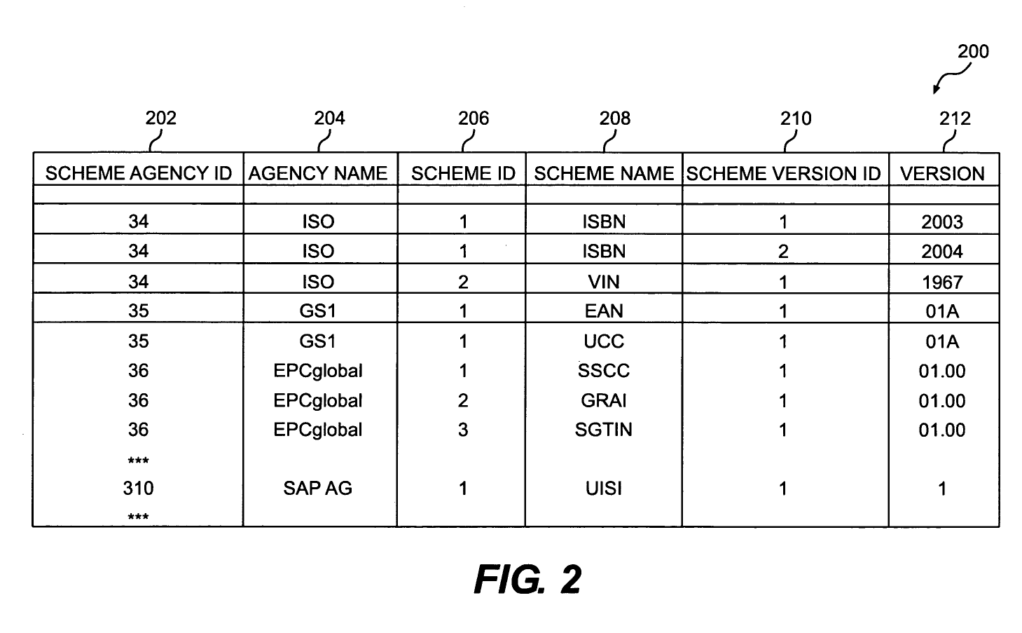

FIG. 2 shows one illustrative table containing encoded scheme agencies and their corresponding schemes that are based on ID assignments associated with these agencies in the UN/CEFACT program mentioned above. It will be understood that FIG. 2 is but one suitable example of an encoded table, any other suitable arrangements may be used without departing from the spirit of the present invention. For example, the content of table 200 may be stored in multiple tables in a relational database, in which scheme agency information and their corresponding scheme information may be presented in different tables.

In table 200, scheme agency ID column 202 may contain unique IDs that have been assigned to the participating agencies. The associated names of the agencies may be stored in corresponding cells in agency name column 204. Scheme ID column 206 may indicate the IDs assigned to each schemes managed by a particular agency. The scheme names may be shown in column 208. As previously mentioned, scheme ID 206 need only be unique with respect to a particular scheme agency ID 202. For example, both scheme agency IDs 34 and 35 in column 202 may have a corresponding scheme ID 1 in column 206. Similarly, each scheme ID in column 206 may be associated with one or more scheme version IDs in column 210. The corresponding version details may be listed in column 212. In this particular exemplary table, positive integers are used to precisely define each type of ID. Using positive integers eliminates ambiguities that may potentially arise from the use of textual values and is generally space efficient and usable in connection with existing physical devices such as barcodes and/or RFID tags, which are also integer-based.

The following describes an application of the HGIS framework to an RFID tag, which is one of the most prevalent applications of unique identifiers. As an overview, manufacturers, retailer, logistics providers, and other users in a supply chain currently use an RFID tag to facilitate tracking, securing, and managing of items from manufacturing to retail. In essence, RFID works by enabling a wireless exchange of information between a tagged object and a reader, which in turn allows a system to process the event information associated with the tagged object.

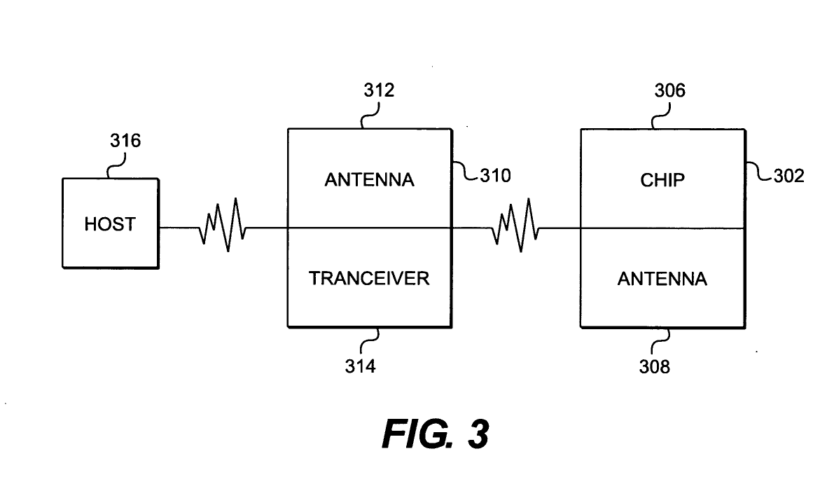

FIG. 3 shows one example of such an RFID system. Three components are included in this basic RFID system 300. First, one or more tags 302 or transponders may be deposited on an item to be tracked. The item may be any suitable item known to those skilled in the art upon which an RFID tag may be attached, such as retail merchandise. The tags 302 may vary in shape, size, and material to suit the conditions of the item. Each RFID tag 302 may include two components, a computer chip 306 and an antenna 308. Appropriate information associated with the tagged item, including, for example, item ID, description, or any other suitable item-related information, may be stored on the computer chip 306 and/or a server away from the tag.

Functionally, tags 302 may fall into two categories, read-only or read/write. Read-only tags are programmed with a fixed set of information during manufacturing, and this information cannot be altered at a later time. Read/write tags on the other hand allow writing and/or rewriting of its information by an authorized user. Some read/write tags may include a read-only portion in which certain information may be stored and protected while allowing other information stored in a writable portion to be modified.

One or more read/write devices or interrogators 310 may be used to communicate with the tags 302. The read/write device 310 may include an antenna 312, a transceiver 314, and any other suitable components for facilitating reading and writing to tags 302. Typically, to communicate with a particular tag or set of tags 302, the read/write device 310 sends out through transceiver 314 and antenna 312 an RF signal in the frequency to which the target tags 302 are tuned. In response to receiving the signal, the targeted tags 302 respond by transmitting at least a part of their stored data. Upon receiving the data transmitted by the tags 302, the reader/writer 310 decodes the data and may transfer the data to a host computer system 316 for processing. The reader/writer 310 may either be fixed-positioned or portable and may be either wired or wireless.

An RFID tag often contains data in the form of an Electronic Product Code (EPC). The EPC is essentially a unique serial code that is assigned to the item to which the RFID tag is affixed or otherwise associated. The tag may also contain EPC-related information, i.e., any suitable information that has been associated with the item bearing an EPC.

Because of its physical characteristics, an RFID tag is particularly suitable for facilitating global unique identification of a physical object through the incorporation of HGIS framework components. More specifically, currently available RFID tags generally have up to 300 bits of space for storing information, which greatly exceeds the typical capacity required for current identification schemes used in connection with RFID tags. For example, the most common specification used in connection with an RFID tag to uniquely identify a physical object is based on an EPCglobal tag data standard. This standard uses 96-bits of the RFID storage capacity.

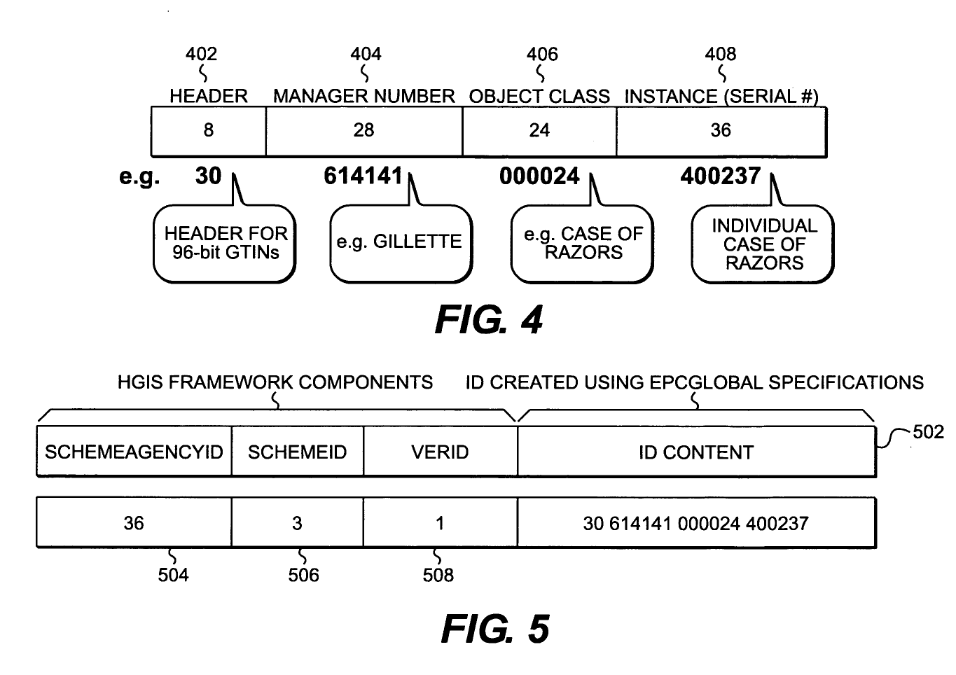

FIG. 4 shows an illustrative example of an EPC encoded in accordance with the 96-bit EPCglobal tag data standard on a RFID tag. As shown in this example, the 96 bits on the RFID tag may be divided into four portions to accommodate EPC-related information. The four portions may include header portion 402, manager number portion 404, object class portion 406, and instance portion 408. The Header portion 402 may store information that corresponds to a tag classification, length, filter value or tag encoding.

Manager number portion 404 may include a manager number that, for example, uniquely identifies an enterprise, such as Gillette, for providing services in connection with a particular group of EPCs. In some embodiments, the manager may own the EPCs for which it provides service. Object class portion 406 may indicate a specific subset of data, for example, within the manager's service scope. In this particular example, the object class relates to cases of razors that are within the manager Gillette's service scope. Finally, instance portion 408 may identify a specific instance of an item bearing the EPC (e.g., to which the RFID is affixed), such as a particular case of razors.

FIG. 5 shows one arrangement for appending HGIS framework components to the above EPC in the RFID of FIG. 4 to transform the RFID from a unique identifier only within the realm the EPCglobal data standard to a global unique identifier that may be recognized across information systems and industries. In this example, the EPC content created using EPCglobal specification as explained above in connection with FIG. 4 is shown in ID content portion 502. This portion may remain unchanged.

HGIS framework components 504-508 may be appended to ID content portion 502, for example, in the form of a header in the RFID tag, to achieve global recognition. Specifically, framework components may include schemeAgencyID 504, schemeID 506, and verID 508. Each of these components may correspond, for example, to scheme agency ID 202, scheme ID 206, and scheme version ID 210 as shown and described in connection with FIG. 2. In particular, a schemeAgencyID value of 36 may correspond to EPCglobal as shown in column 204 of FIG. 2. A schemeID value of 3 may correspond to EPCglobal scheme SGTIN, which is currently the scheme used to govern EPC assignments. A verID value of 1 may simply indicate the only version of the SGTIN scheme currently in use.

As previously explained, these values are already in existence for unique identification of the scheme agency, their corresponding identification scheme, and scheme version in the UN/CEFACT database. It is noted that these values are all in integer form, making transforming and/or representing them in a bit-stream, such as one required for encoding an RFID tag, very efficient. In fact, the example of FIG. 5 may be encoded on an RFID tag in as little as 128 bits, which is well within the current capacity of broadly available RFID tags. It should also be noted that the same ID having HGIS framework components incorporated within may be expressed just as easily as a 16-byte barcode.

It will be understood that the above example is provided as one specific embodiment for appending HGIS framework components to an RFID tag. Any other suitable arrangements may be used without departing from the spirit of the present invention.

The above examples illustrate how the HGIS framework may enable existing identification specifications and/or standards to achieve uniqueness for the objects identified through these existing specifications and/or standards in a global information landscape without altering the original ID instance. The HGIS framework may be extended to include an extended global identification system (EGIS), which may operate within the HGIS framework and enable unique identification of virtual objects as well as physical objects across information systems in different industries and through other information system barriers.

In the context of EGIS, a virtual object may be any object or data instance that is created by an information system and is capable of being uniquely identified, for example, by an identifier such as an ID. Examples of virtual objects may include, for example, an instance of an invoice, an instance of a purchase order, an instance of a ship notice, or any other suitable data instance. EGIS that is embedded within the HGIS framework may function based on the same basic principle set out in the HGIS framework. For example, every ID instance that identifies a virtual object may be encapsulated within appropriate EGIS framework components in the same fashion as shown and explained in connection with FIG. 1 to provide unambiguous unique identification. This also means that each ID instance of a virtual object may additionally be associated with, for example, a scheme agency ID 104, scheme ID 106, and scheme version ID 108 as shown in FIG. 1.

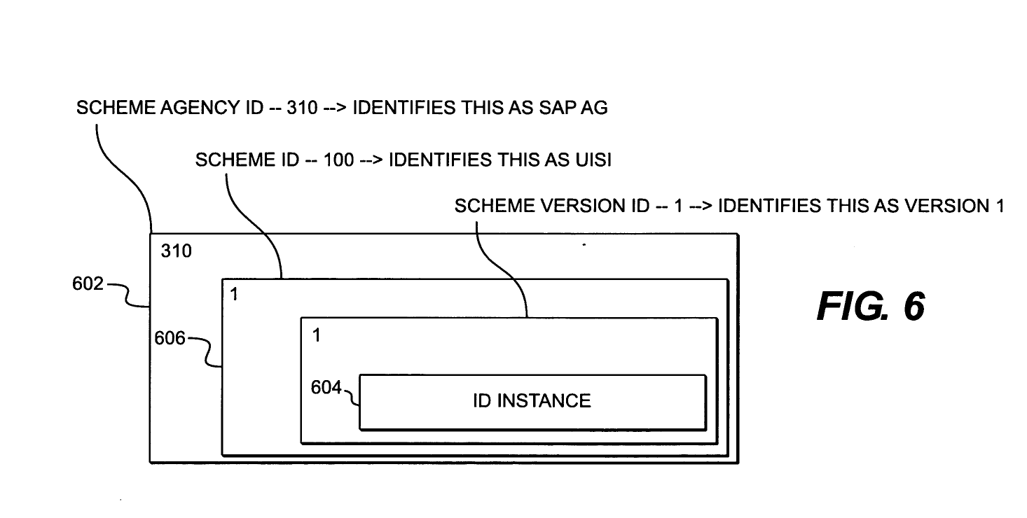

In one suitable example shown in FIG. 6, the enterprise “SAP AG,” which is listed as being associated with scheme agency ID value 310 in column 202 of FIG. 2, may be the scheme agency 602 that is identified as being the manager and/or owner of a particular virtual object (e.g., an invoice) represented by ID instance 604. Within the scheme agency “SAP AG,” an identification scheme according to which virtual object ID instance 604 is created may be identified by a scheme ID 606. In one suitable embodiment, the scheme represented by scheme ID 606 may be a Unique Information System Identifier (UISI) scheme specifically established to govern the creation and management of a certain type of virtual objects. It will be understood that while UISI is used to refer to a virtual object scheme in this example, any other suitable scheme for virtual object identification may be used without departing from the spirit of the present invention. The UISI scheme may be registered, for example, in the table of FIG. 2 as being associated with scheme agency ID value 310, which corresponds to “SAP AG.” Using this method or any other suitable method, UISI may be made known to other information systems as a scheme for the identification of a particular type of virtual objects.

In one suitable arrangement, UISI may be a default scheme, for example, defined by “SAP AG” to provide for the unique identification of virtual objects managed by an SAP information system. In an enterprise or scheme agency that utilizes complex information systems to manage a variety of virtual objects, a plurality of such default schemes may be defined to govern the identification of an array of virtual object types. Some exemplary virtual object identification schemes are shown in the table below. It will be understood that many more virtual object identification schemes may be defined to manage additional virtual object types without departing from the spirit of the present invention.

TABLE 2

| Scheme ID | Scheme Name |
|---|---|
| 1 | Invoice |
| 2 | Purchase Order |
| 3 | Sales Order |
| 4 | Expense Report |
| 5 | Advanced Ship Notice |
| 6 | Remittance Advice |
| 7 | Customer Record |
| 8 | Bill of Materials |
| 9 | Employee Report |
| 10 | Shipping Container |
| 11 | Pallet |
| 12 | Returnable Asset |
| 13 | Managed Asset |

Each virtual object identification scheme such as the ones shown above may be represented, for example, in the table of FIG. 2 in association with a scheme agency ID, such as the one corresponding to “SAP AG.” In this way, an external information system may determine the scheme agency that manages the definition of a particular ID instance of a virtual object as well as the specific identification scheme used to create the ID instance simply by examining the framework components appended to the ID instance. For example, when a retailer receives a virtual object (e.g., a data instance) in its information system from an information system associated with “SAP AG” that is encapsulated by appropriate framework components (e.g., scheme agency ID having a value of 310 and scheme ID of 1), the retailer may immediately determine, based on the framework components, that the virtual object is defined by “SAP AG” and is an instance ID for an invoice.

A number of EGIS components may be included to define, for example, the information system within the scheme agency and the specific scheme used by that information system to generate the ID instance. The identified information system, as represented by an information system ID, may be responsible for ensuring that the ID instance is unique within that system. A system identification scheme ID component may uniquely identify a particular identification scheme of the information system that defines, for example, how the ID instance is constructed. More specifically, the scheme may, for example, describe the numbering algorithm that was used to derive the ID content and/or how the ID content is represented, such as where separators are used in the ID instance and/or what the different parts of a complex key stand for. The UISI may additionally include a system scheme version ID, which may uniquely identify the version of the identification scheme used to generate a particular ID instance. If there are no multiple versions of the scheme, the system scheme version ID may simply be set to a default value (e.g., 1).

In some embodiments, the UISI may include only one unique ID for the identification of the virtual object and/or any specific fields that are deemed necessary for providing business process interoperability and flexibility associated with the virtual object. As an example, for a virtual object that is an invoice, the scheme for defining the invoice ID instance may include, for example, a single unique invoice number.

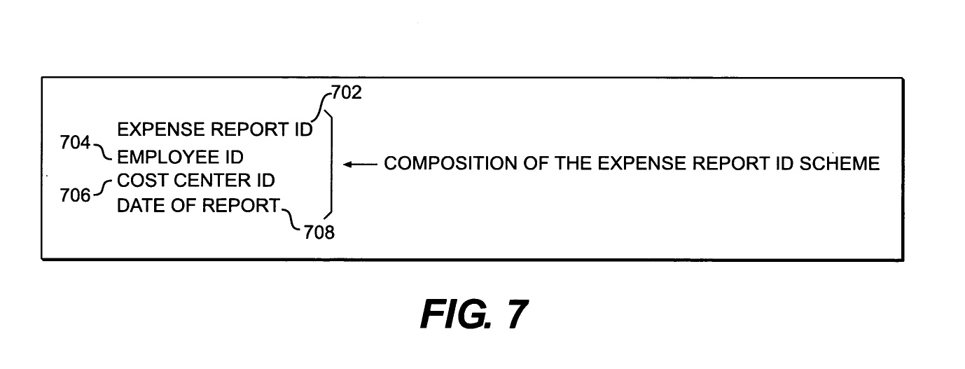

In a more complex identification scheme, multiple unique identifiers may be defined in a single ID instance of a virtual object. FIG. 7 shows one example of such a virtual object, which represents an expense report instance. Within this expense report instance, a number of unique identifiers may be found. In this example, the expense report instance includes an expense report ID 702, an employee ID 704, a cost center ID 706, and a date of report 708. Any other suitable identifiers necessary for the interoperability of the virtual object may be included without departing from the spirit of the present invention.

As illustrated above, the combination of EGIS components and HGIS components provide a number of advantages for information systems and business processes that are supported by these information systems. Most of all, the combination enables an identifier that is unique in a particular information system to retain that uniqueness across a diverse landscape of internal and/or external information systems. This eliminates the need to transform or map the identifier between systems as is routinely done today. As a result, the disclosed system and method eliminate many potential processing errors and significantly increases system efficiency. The explicit identification of the scheme by the EGIS framework components provides for unambiguous semantic interpretation of the scheme by other information systems. These systems no longer have to assume the context of any ID instance it receives from an external system and, therefore, significantly reduces processing errors from ambiguous definitions. In addition, application of both HGIS and EGIS does not require modification to physical devices such as barcodes and RFID tags, which have limited capacity. Both the HGIS and EGIS frameworks are capable of being implemented within the current limitations of these physical devices.

It will be understood that the above illustrative application of both the HGIS and EGIS frameworks are merely provided as examples. Any other suitable applications may be implemented without departing from the spirit of the present invention.

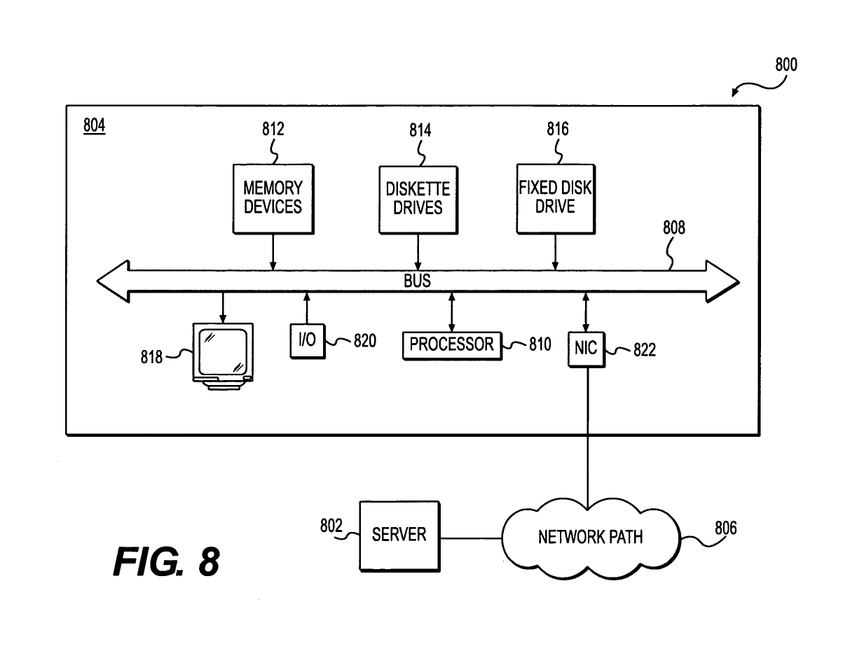

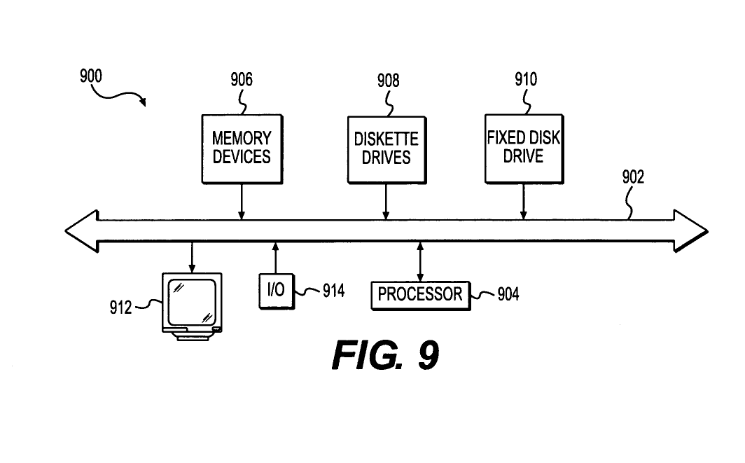

A computer system may be used to install a software application implementing a system and method for supporting an information system capable of implementing the HGIS and EGIS frameworks. The computer system may be a computer network, as shown in FIG. 8, or a stand-alone personal computer (PC), as shown in FIG. 9.

As shown in FIG. 8, a computer network 800 in accordance with systems consistent with the principles of the present invention may include a server 802 and a stand-alone PC 804 connected through a network path 806. Computer network 800 may be a local area network (LAN), where server 802 and PC 804 are workstations. Computer network 800 may also be the Internet, with server 802 hosting a web application and PC 804 being any workstation available to a user desiring to interface with the application on server 802. Alternatively, computer network 800 may be a wide area network (WAN), and server 802 and PC 804 may lie in two separate LANs connected through the Internet.

PC 804 may include a bus line 808 connecting a plurality of devices such as a processor 810, memory devices 812 for storage of information, diskette drives 814, a fixed disk drive 816, a monitor or display 818, other I/O devices 820, and a network interface card (NIC) 822. Processor 810 may be a microprocessor such as an Intel Pentium™ chip for processing applications. Memory devices 812 may include read-only memories (ROM) and/or random access memories (RAM). Diskette drives 814 may include a floppy drive and/or a compact disk (CD) drive. Fixed disk drive 816 may be a hard drive. I/O devices 820 may include a keyboard and/or a mouse for receiving input from a user of PC 804. Monitor or display 818 may display output from processor 810, and may also echo the input of the user. PC 804 may be connected to network path 806 through NIC 822.

A web application may be installed on server 802. An individual desiring to enter data into the application on server 802 may use a web browser loaded on PC 804, and may communicate with server 802 through NIC 822 and network path 806. In one aspect, software application for implementing a system consistent with the principles of the present invention may be stored in PC 804 and processor 810 of PC 804 may execute the software application locally within PC 804 and interface with a web application on server 802. Particularly, the software application may be stored on a floppy disk, a CD, or any other suitable readable media, which may be accessible by diskette drive 814, fixed disk drive 816, or any other suitable mechanism. In another aspect, the software application for implementing a system consistent with the principles of the present invention may be stored in server 802, which may execute the software application, and processor 810 of PC 804 may communicate with server 802 to send information to server 802 and retrieve the results of the execution of the software application from server 802.

Through the execution of the software application implementing a system consistent with the principles of the present invention, either locally within PC 804 or remotely within server 802, an interface or screen may be provided on a user display.

Alternatively, as shown in FIG. 9, a stand-alone PC 900 may be used for implementing a software application implementing a system consistent with the principles of the present invention. PC 900 may include a bus line 902 connecting a plurality of devices, which may include a processor 904, memory devices 906 for storage of information, diskette drives 908, a fixed disk drive 910, a monitor or display 912, and other I/O devices 914. Processor 904 may be a microprocessor such as an Intel Pentium™ chip for processing applications. Memory devices 906 may include ROM and/or RAM. Diskette drives 908 may include a floppy drive and/or a compact disk (CD) drive. Fixed disk drive 910 may be a hard drive. Monitor or display 912 may display the output of processor 904 and may also echo the input of the user. I/O devices 914 may include a keyboard and/or a mouse for receiving input from a user of PC 900.

A software application implementing a system consistent with the principles of the present invention may be stored on a floppy disk or a CD accessible by diskette drive 908 or on fixed disk drive 910. Processor 904 may execute the software application stored in the floppy disk the CD or the fixed disk drive 910. An individual, through monitor or display 912 and I/O devices 914, may interact with processor 904, which may execute the software application. A software application implementing a system consistent with the principles of the present invention may be written in any number of programming languages, including but not limited to JavaScript, Visual Basic, Flash, ABAP coding, or any other suitable language. Similarly, the present invention is not limited to use with certain applications, Internet browsers or operating systems.

Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

While the present invention has been described in connection with various embodiments, many modifications will be readily apparent to those skilled in the art. One skilled in the art will also appreciate that all or part of the systems and methods consistent with the present invention may be stored on or read from computer-readable media, such as secondary storage devices, like hard disks, floppy disks, and CD-ROM; a carrier wave received from a network such as the Internet; or other forms of ROM or RAM. Accordingly, embodiments of the invention are not limited to the above described embodiments and examples, but instead is defined by the appended claims in light of their full scope of equivalents.

What is claimed is:

1. A method for uniquely identifying an object globally across information systems, comprising:
identifying a scheme agency identifier corresponding to a scheme agency responsible for a scheme used to construct an object identifier;
identifying a scheme identifier associated with the particular scheme used to construct the object identifier; and
encapsulating the object identifier with the scheme agency identifier and the scheme identifier, wherein the encapsulation enables an external information system to uniquely identify the object.

2. The method of claim 1, further comprising:
identifying a version identifier associated with a version of the scheme used to construct the object identifier; and wherein encapsulating the object identifier comprises encapsulating the object identifier with the scheme agency identifier, the scheme identifier, and the version identifier, wherein the encapsulation enables an external information system to uniquely identify the object.

3. The method of claim 1, wherein the object identifier is encoded on an RFID tag and encapsulating the object identifier comprises appending the scheme agency identifier and the scheme identifier to the RFID tag.

4. The method of claim 1, wherein the object identifier is encoded in a barcode and encapsulating the object identifier comprises appending the scheme agency identifier and the scheme identifier to the barcode.

5. The method of claim 1, wherein the object is a virtual object and the particular scheme used to construct the object identifier comprises a system identifier identifying an information system from which the object identifier is generated and a system scheme identifier identifying an identification scheme of the information system based on which the object identifier is generated; and
encapsulating the object identifier with the system identifier and the system scheme identifier.

6. The method of claim 5, further comprising encapsulating the encapsulated object identifier with the scheme agency identifier, the scheme identifier, and the version identifier, wherein the encapsulation enables an external information system to uniquely identify the virtual object instance.

7. A system for uniquely identifying an object globally across information systems, comprising a processor configured to:
identify a scheme agency identifier corresponding to a scheme agency responsible for a scheme used to construct an object identifier;
identify a scheme identifier associated with the particular scheme used to construct the object identifier; and
encapsulate the object identifier with the scheme agency identifier and the scheme identifier, wherein the encapsulation enables an external information system to uniquely identify the object.

8. The system of claim 7, where the processor is further configured to:
identify a version identifier associated with a version of the scheme used to construct the object identifier; and wherein the processor is configured to encapsulate the object identifier with the scheme agency identifier, the scheme identifier, and the version identifier, wherein the encapsulation enables an external information system to uniquely identify the object.

9. The system of claim 7, wherein the object identifier is encoded on an RFID tag and the processor is configured to append the scheme agency identifier and the scheme identifier to the RFID tag.

10. The system of claim 7, wherein the object identifier is encoded in a barcode and the processor is configured to incorporate the scheme agency identifier and the scheme identifier to the barcode.

11. The system of claim 7, wherein the object is a virtual object and the particular scheme used to construct the object identifier comprises a system identifier identifying an information system from which the object identifier is generated and a system scheme identifier identifying an identification scheme of the information system based on which the object identifier is generated; and
the processor is configured to encapsulate the object identifier with the system identifier and the system scheme identifier.

12. The system of claim 11, wherein the processor is further configured to encapsulate the encapsulated object identifier with the scheme agency identifier, the scheme identifier, and the version identifier, wherein the encapsulation enables an external information system to uniquely identify the virtual object instance.
